(19) United States
(12) Patent Application Publication
(10) Pub. No.: US 2024/0308711 A1
(43) Pub. Date: Sep. 19, 2024

(54) HIGH SPEED WRAPPER

(71) Applicant: Rehrig Pacific Company, Los Angeles, CA (US)

(72) Inventors: Peter Douglas Jackson, Alpharetta, GA (US); Dane Gin Mun Kalinowski, Foothill Ranch, CA (US); Justin Corless, Flower Mound, TX (US)

(21) Appl. No.: 18/608,431

(22) Filed: Mar. 18, 2024

Related U.S. Application Data
(60) Provisional application No. 63/452,974, filed on Mar. 17, 2023.

(51) Int. Cl. B65B 65/00; B65B 11/02; B65B 57/00; B65G 21/20

(52) U.S. Cl. CPC B65B 65/006; B65B 11/025; B65B 57/00; B65G 21/20; B65B 2210/14

(57) ABSTRACT

A conveyor system includes a plurality of conveying surfaces spaced apart from one another. An upper floor between the plurality of conveying surfaces has an uppermost surface that is lower than an uppermost surface of the plurality of conveying surfaces and higher than a returning portion of the plurality of conveying surfaces. This permits the conveyor system to be used with nestable pallets and base board pallets. The conveyor system may be part of a pallet wrapping system having an infeed conveyor and an outfeed conveyor for receiving loaded pallets from tines of material handling equipment and for transferring wrapped loaded pallets to tines of material handling equipment.

### BACKGROUND

The delivery of products to stores from distribution centers has many steps that are subject to errors and inefficiencies. When an order from the store is received, a plurality of pallets are each loaded with the products (SKUs) specified in a “pick list.”

For example, the products may be packages of beverage containers (e.g. cartons of cans, beverage crates containing bottles or cans, cardboard trays with plastic overwrap, etc). There are many different permutations of flavors, sizes, and types of beverage containers delivered to each store. When building pallets, missing or mis-picked product can account for significant additional operating costs.

The assignee of the present invention has developed a validation system in which a plurality of products stacked on a pallet or other platform are imaged. The images are then analyzed using at least one machine learning model to identify the SKUs associated with the plurality of products stacked on the pallet. The identified SKUs are then compared to the SKUs on the pick list or order. If necessary, missing products can be added or incorrect products can be corrected before the pallet is shipped to the store.

### SUMMARY

A conveyor system includes a plurality of conveying surfaces spaced apart from one another. An upper floor between the plurality of conveying surfaces has an uppermost surface that is lower than an uppermost surface of the plurality of conveying surfaces and higher than a returning portion of the plurality of conveying surfaces. This permits the conveyor system to be used with both nestable pallets and base board pallets and without the need for a forklift.

In one embodiment, the uppermost surface of the conveying surfaces is approximately ½″ higher than the uppermost surface of the upper floor.

The conveyor system may be part of a pallet wrapping system having an infeed conveyor and an outfeed conveyor for receiving loaded pallets from tines of material handling equipment and for transferring wrapped loaded pallets to tines of material handling equipment.

First and second pallet wrapping systems may be parallel to one another with offset wrappers so that the first and second pallet wrapping systems can be positioned closer to one another in a lateral direction. This reduces the overall footprint of a plurality of pallet wrapping systems, which can be more densely deployed in a warehouse.

### BRIEF DESCRIPTION OF THE DRAWINGS

FIG. 1 shows one possible configuration of a conveyor, wrapper, and validation system.

FIG. 2 shows a system according to a second embodiment.

FIG. 3 shows a system according to a third embodiment.

FIG. 4 shows the systems of FIGS. 2 and 3 positioned next to one another.

FIGS. 5 and 6 are perspective views of the wrapper.

FIG. 7 shows a first step in using the system of FIG. 2.

FIG. 8 shows a second step in using the system of FIG. 2.

FIG. 9 shows a third step in using the system of FIG. 2.

FIG. 10 shows a fourth step in using the system of FIG. 2.

FIG. 11 shows a fifth step in using the system of FIG. 2.

FIG. 12 shows a sixth step in using the system of FIG. 2.

FIG. 13 shows a first step in using the system of FIG. 3.

FIG. 14 shows a second step in using the system of FIG. 3.

FIG. 15 shows a third step in using the system of FIG. 3.

FIG. 16 shows a fourth step in using the system of FIG. 3.

FIG. 17 shows a fifth step in using the system of FIG. 3.

FIG. 18 shows a sixth step in using the system of FIG. 3.

FIG. 19 shows a more specific, optional implementation of the infeed conveyor that could be deployed in any of the configurations herein.

FIG. 20 is a front perspective view of the portion of the infeed conveyor of FIG. 19.

FIG. 21 is a section view taken along line A-A of FIG. 20.

FIG. 22 shows one of the nestable pallets on the infeed conveyor of FIG. 21.

FIG. 23 shows one of the base board pallets on the infeed conveyor of FIG. 21.

FIG. 23A is a top view of the infeed conveyor of FIG. 19 with a plurality of nestable pallets and a plurality of base board pallets.

FIG. 24 is a perspective view of the entire infeed conveyor of FIG. 19, between the leading portion and the transfer conveyor.

FIG. 25 is a perspective view of the transfer conveyor and the weigh conveyor.

FIG. 26 is a perspective view of the weigh conveyor, wrapper conveyor, wrapper and outfeed queue conveyor.

FIG. 27 is a perspective view of the outfeed queue conveyor, the outfeed conveyor, and a leadaway portion.

### DETAILED DESCRIPTION

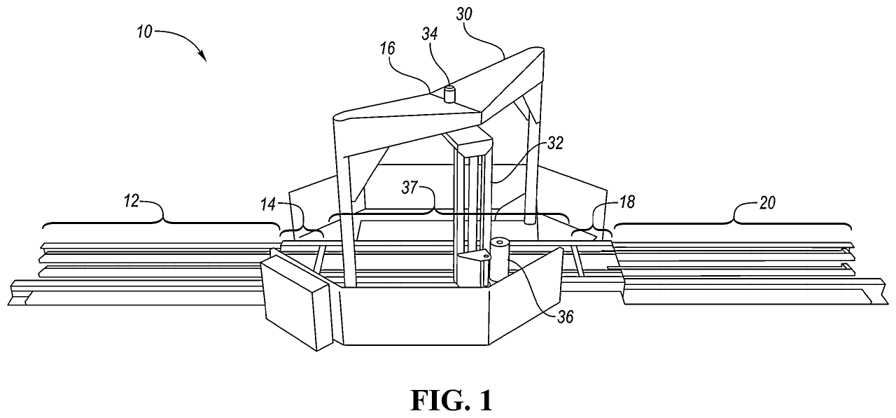

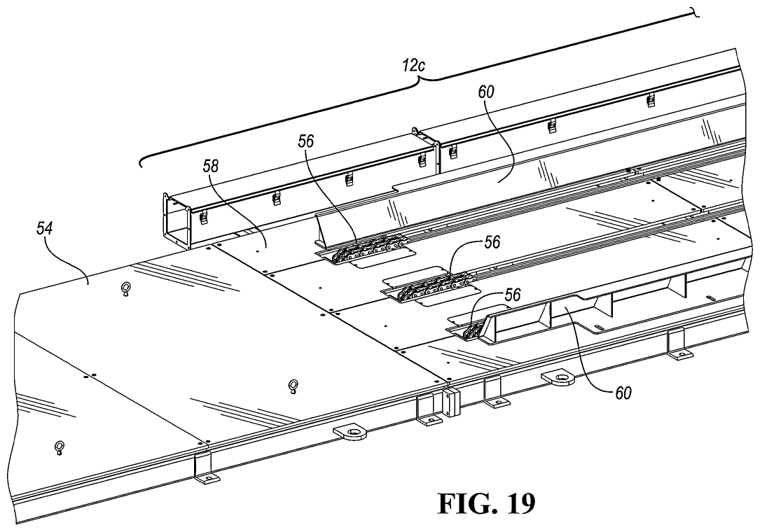

FIGS. 1 to 18 show possible configurations of a conveyor, wrapper, and validation system. FIGS. 19-27 show a more specific, optional implementation of the conveyor, wrapper, and validation system that could be deployed in the configurations of FIGS. 1-18.

Referring to FIG. 1, a system 10 according to a first embodiment includes an infeed conveyor 12 leading to a transfer conveyor 14, which in turn leads to a wrapper conveyor 37 within a wrapper 16, which in turn leads to a weigh conveyor 18, which in turn leads to an outfeed conveyor 20.

In this embodiment, he infeed conveyor 12 is very low to the floor so that pallets can be placed on it easily, such as directly from tines of a standard walkie rider (or pallet jack or pallet sled or other material handling equipment with load wheels directly under the tines) without requiring a forklift (i.e. which does not have load wheels directly under the tines). The transfer conveyor 14 raises the pallets to the height of the wrapper conveyor 37 and transfers the pallets one at a time to the wrapper conveyor 37. After passing through the wrapper conveyor 37, each pallet would be transferred to a weigh conveyor 18 on which a loaded pallet is weighed. The weigh conveyor 18 then transfers the pallet down to the outfeed conveyor 20, which again is low to the floor so that pallets can be transferred to the tines of a standard walkie rider.

The wrapper 16 includes an overhead gantry 30 to which is mounted a vertical arm 32 that is spaced outward from an axis 34 about which the arm 32 rotates. A roll of plastic stretch wrap 36 (or other suitable wrap) is rotatably secured to the arm 32 to be dispensed about a load of items (such as products, which may be packages) on a pallet within the wrapper 16. Such wrappers are well known and commercially available.

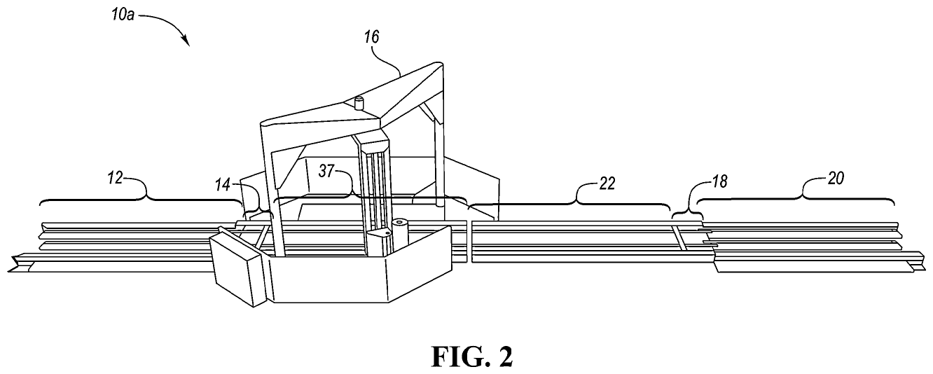

FIG. 2 shows a system 10a according to a second embodiment. The system 10a is identical to that of FIG. 1 except as specifically shown or described. Namely, an outfeed queue conveyor 22 is interposed between the wrapper conveyor 37 and the weigh conveyor 18.

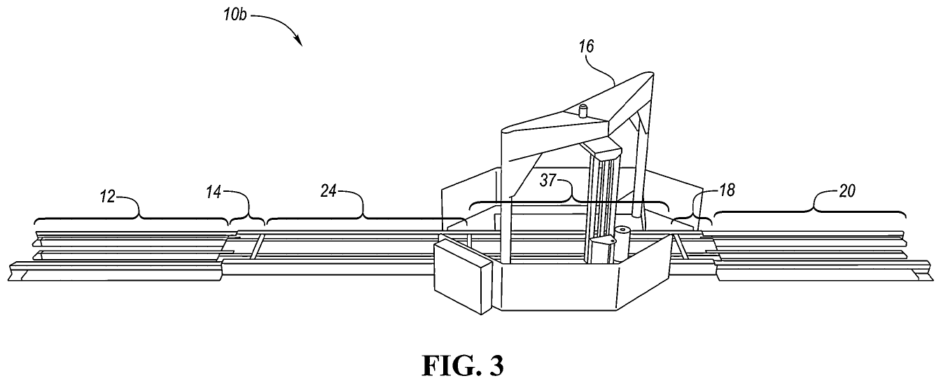

FIG. 3 shows a system 10b according to a third embodiment. The system 10b is identical to that of FIG. 1 except as specifically shown or described. Namely, an infeed queue conveyor 24 is interposed between the wrapper conveyor 37 and the infeed conveyor 12.

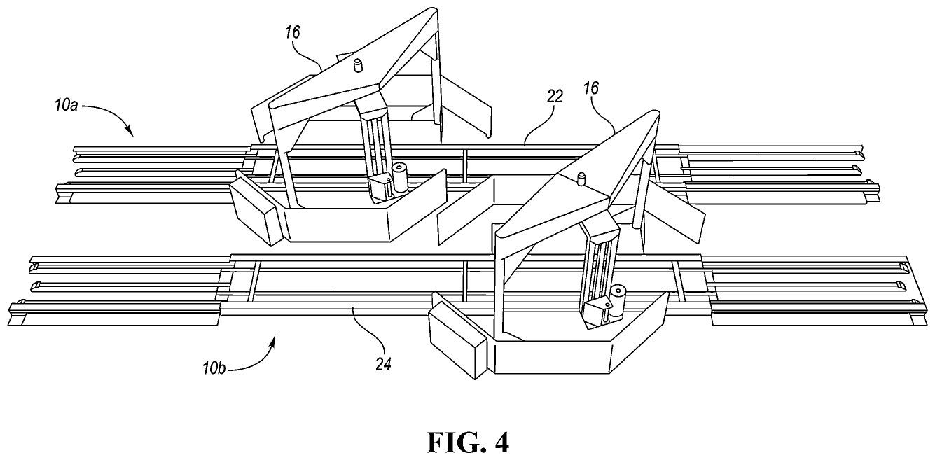

As shown in FIG. 4, the system 10a and the system 10b can be efficiently placed next to one another as shown, with the wrapper 16 of the system 10a aligned with the infeed queue conveyor 24 of the system 10b and with the wrapper 16 of the system 10b aligned with the outfeed queue conveyor 22 of the system 10a. The longitudinal axes (i.e. the direction of travel on the conveyors) of the two systems 10a, 10b are substantially parallel to one another. As can be seen, the wrappers 16 are by far the widest portions of the two systems 10a, 10b (i.e. the largest portions in a lateral direction perpendicular to the longitudinal axes, or perpendicular to the direction of travel on the conveyors). If the two systems 10a, 10b were the same and if the two wrappers 16 were aligned, then the two systems 10a, 10b would have to be spaced further apart and the two systems 10a, 10b would occupy more floor area in total.

Another system 10a can also be positioned on the other side of the system 10b, and additional systems of the two configurations can be positioned accordingly in an alternating fashion. In this manner, with the alternating systems 10a, 10b having longitudinally offset wrappers 16, approximately 50% more systems can fit in the same floor area as systems in which the wrappers 16 are aligned.

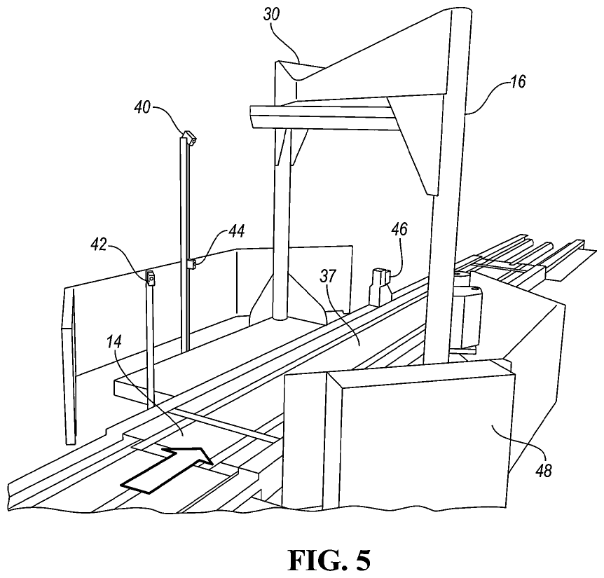

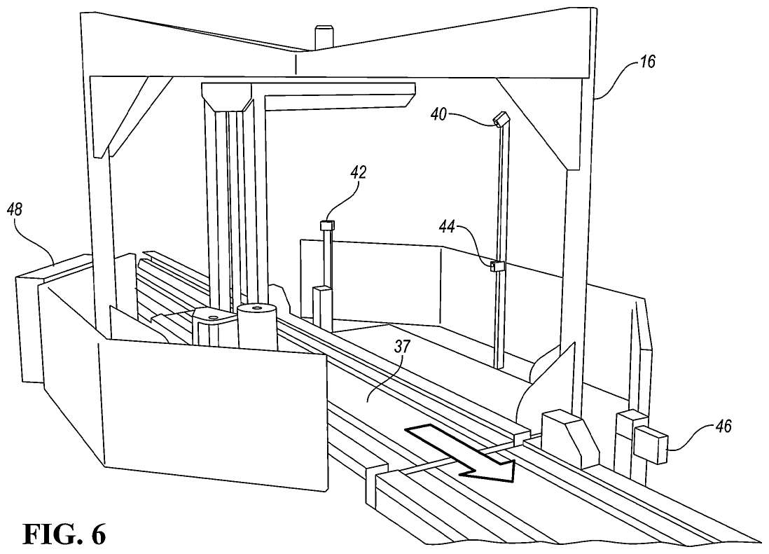

FIGS. 5 and 6 show more detail of the wrapper 16 that may be used in any of the embodiments disclosed herein. The wrapper 16 includes at least one and preferably a plurality of cameras adjacent the transfer conveyor 14 directed to the portion of the transfer conveyor 14 below the overhead gantry 30. The cameras include one or more of (and optionally all): a top camera 40 positioned higher than a load on the pallets would be, such as on a pole and directed downward; a side camera 44 for imaging a side of the load of goods on a pallet and at a height approximately mid-way up an expected height of the goods on the pallet; and a front camera 42. Additional cameras may be placed on the other side of the pallet. Alternatively, or in addition, a camera could be placed on the arm 32 of the wrapper 16 so that it travels around the loaded pallet.

Additionally, an RFID reader 46 may be positioned adjacent the conveyor just past the wrapper conveyor 37 for reading an RFID tag on the pallet after it is wrapped by the wrapper 16. The reader 46 could alternatively be positioned adjacent the wrapper conveyor 37 or just upstream of the wrapper conveyor 37.

The images from the cameras 40, 42, 44 and the information from RFID reader 46 are sent to a computer 48. The computer 48 includes at least one processor and at least one computer readable storage medium storing instructions which when executed by the at least one processor perform the functions described herein. The at least one storage medium may also include one or more machine learning models trained on images of the goods that may be expected to be on the pallets, such as all the goods available in the warehouse. The machine learning models can be trained by manually identifying the items (again, such as products, which may be packages) in each of the images and training the models based upon the known images in a known manner. Unless otherwise explicitly stated otherwise, the computer 48 could be more than one computer, including virtual computers and computers at different locations and of different types and the term “computer” as used herein (including the claims) has that meaning.

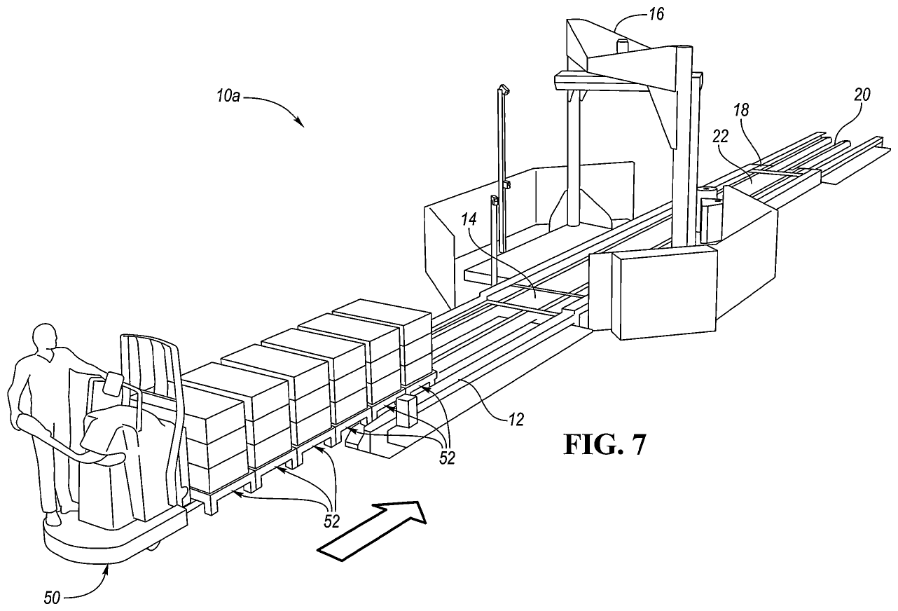

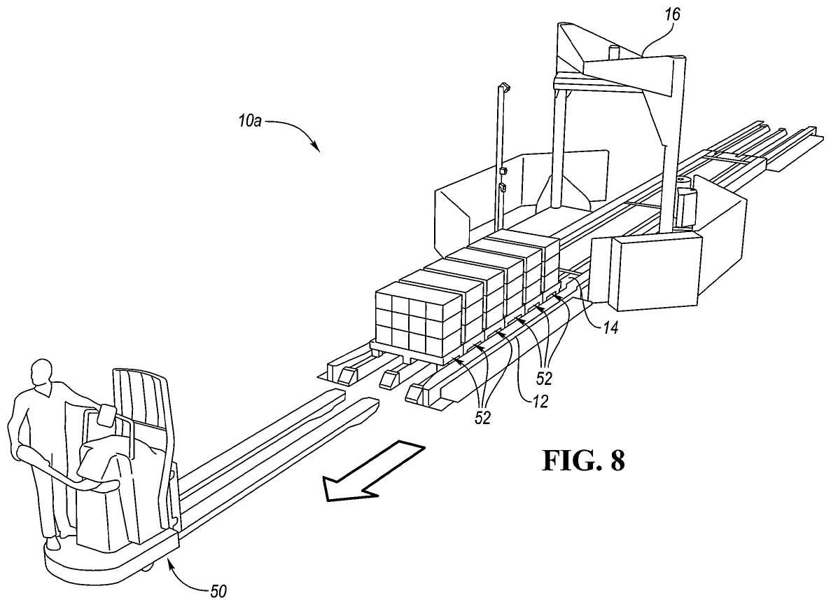

FIG. 7 shows a first step in using the system 10a of FIG. 2. A user driving a walkie rider 50 (or pallet lift or pallet sled or pallet jack or other material handling equipment) brings a plurality of loaded pallets 52 and places them on the infeed conveyor 12. Referring to FIG. 8, the user and walkie rider 50 are then free to leave, with the plurality of loaded pallets 52 on the infeed conveyor 12. The user can then take the walkie rider 50 and load additional pallets with goods according to orders received from stores (for example).

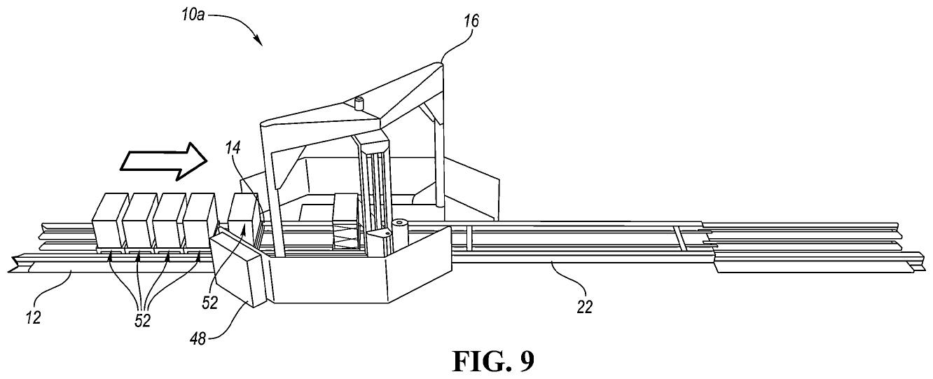

Referring to FIG. 9, the system 10a (as controlled by the computer 48) operates the infeed conveyor 12 to move each loaded pallet 52 to the transfer conveyor 14 one at a time. The transfer conveyor 14 takes the first loaded pallet 52 and moves it to the wrapper conveyor 37. The wrapper conveyor 37 moves the first loaded pallet 52 into the wrapper 16, where the loaded pallet 52 is imaged by the plurality of cameras 40, 42, 44 and then wrapped by the wrapper 16. The images of the loaded pallet 52 are sent to the computer 48 for analysis, such as identification of the SKUs associated with each of a plurality of packages loaded on the pallet 52 and comparison to a pick list.

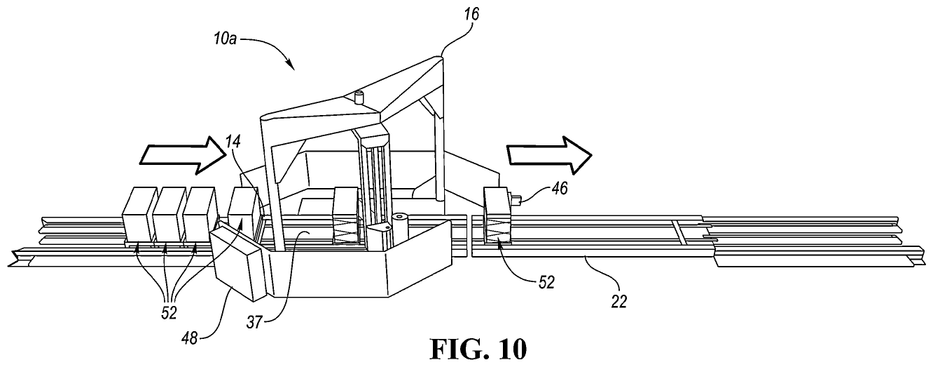

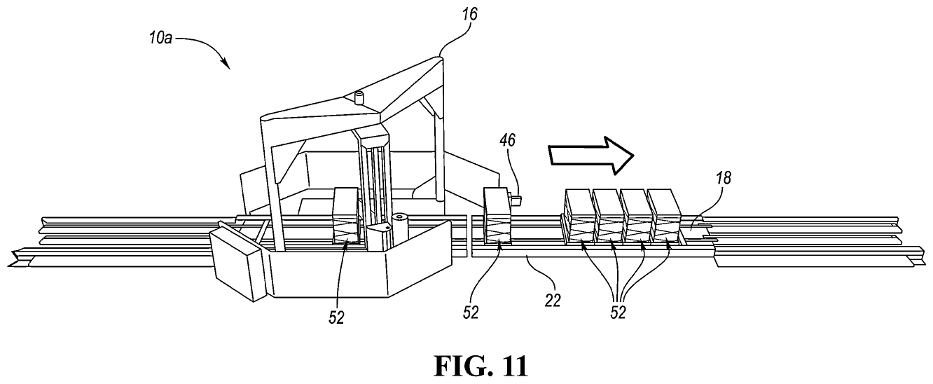

Referring to FIG. 10, the wrapper conveyor 37 is then controlled by the computer 48 so that the first loaded, wrapped pallet 52 is moved to the outfeed queue conveyor 22 where it passes the RFID reader 46 where a pallet RFID tag on the pallet 52 is read and passed to the computer 48. At the same time, the next loaded pallet 52 is moved by the transfer conveyor 14 to the wrapper conveyor 37 so that it can be wrapped and imaged by the wrapper 16. This continues as shown in FIG. 11, as the loaded, wrapped pallets 52 accumulate on the outfeed queue conveyor 22.

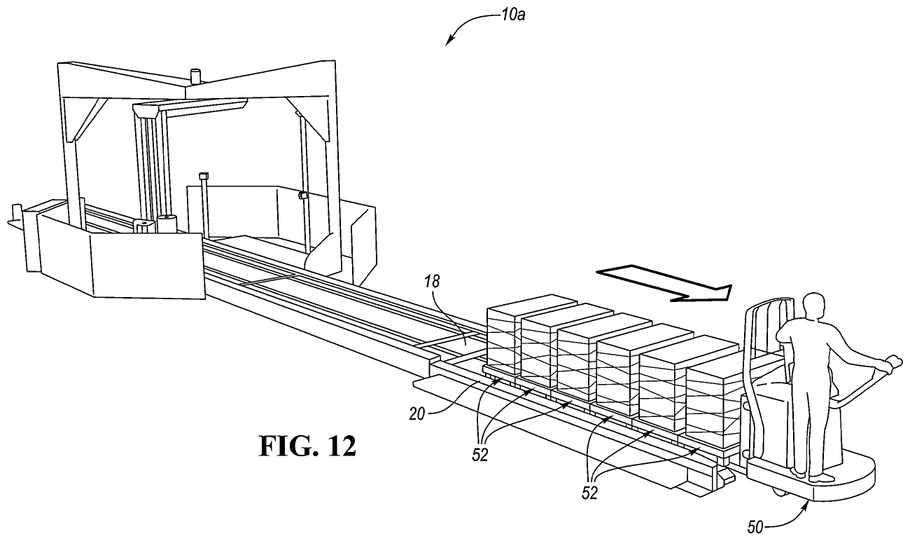

Referring to FIG. 12, the loaded, wrapped pallets 52 wait on the outfeed conveyor 20, and then each of the loaded, wrapped pallets 52 is weighed one at a time on the weigh conveyor 18 and is then transferred to the outfeed conveyor 20. The weight of each loaded pallet 52 is sent to the computer 48 to be used for SKU verification. When all of the loaded, wrapped pallets 52 are on the outfeed conveyor 20, they can all be picked up by the walkie rider 50. Again, while this imaging and wrapping process has been taking place, the user and the walkie rider 50 can be picking other orders and loading other pallets 52 and placing them on the infeed conveyor 12.

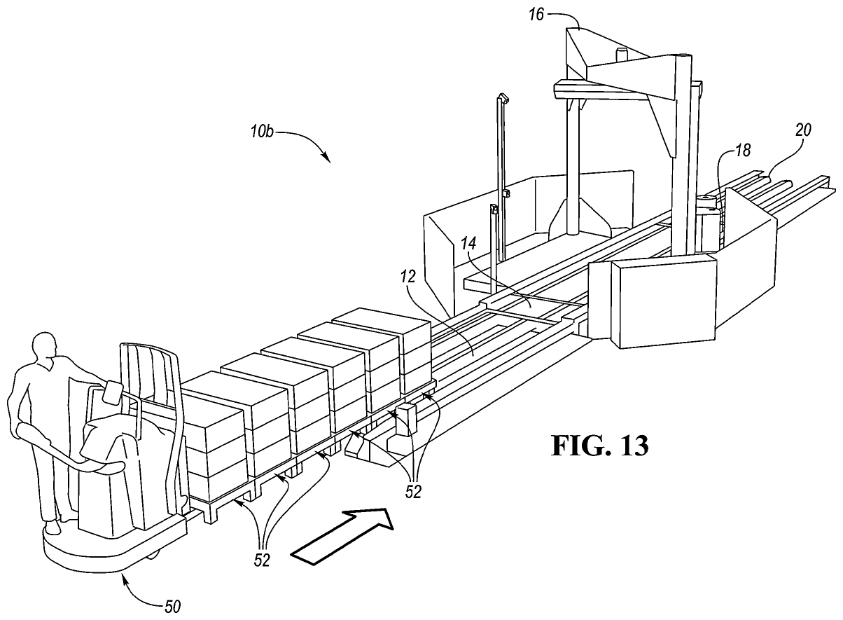

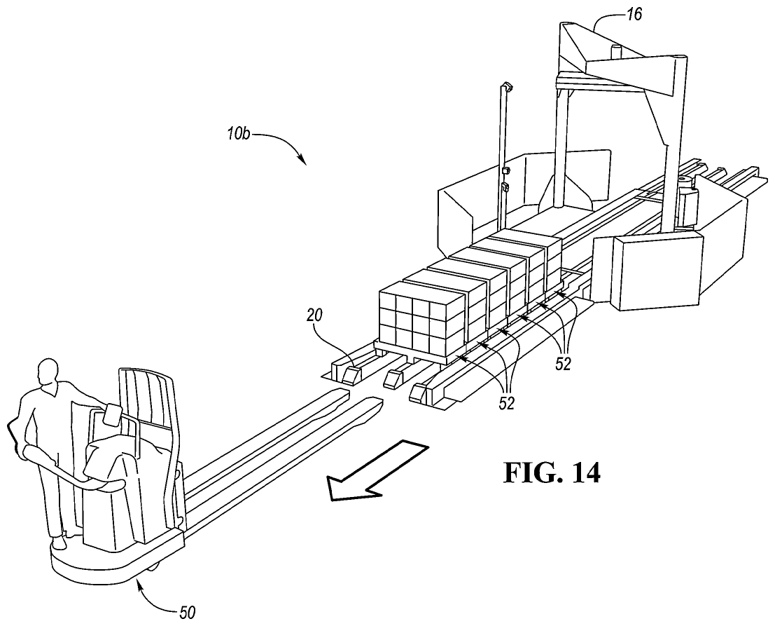

FIG. 13 shows a first step in using the system 10b of FIG. 3. The user driving the walkie rider 50 (or pallet lift or pallet sled or pallet jack) brings the plurality of loaded pallets 52 and places them on the infeed conveyor 12. Referring to FIG. 14, the user and walkie rider 50 are then free to leave, with the plurality of loaded pallets 52 on the infeed conveyor 12. The user can then take the walkie rider 50 and load additional pallets with goods according to orders received from stores (for example).

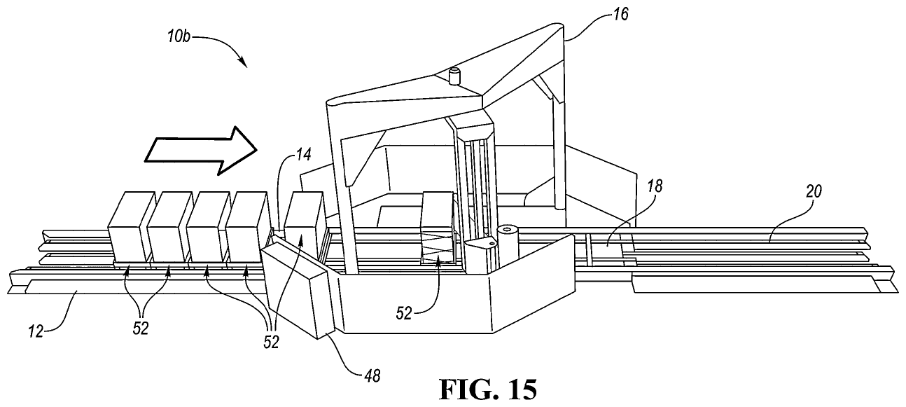

Referring to FIG. 15, the system 10b (as controlled by the computer 48) operates the conveyor 12 to move each loaded pallet 52 onto the transfer conveyor 14, which takes only one loaded pallet 52 and moves it to the wrapper conveyor 37. The wrapper conveyor 37 moves the one loaded pallet 52 below the wrapper 16, where the loaded pallet 52 is imaged by the plurality of cameras 40, 42, 44 and wrapped by the wrapper 16.

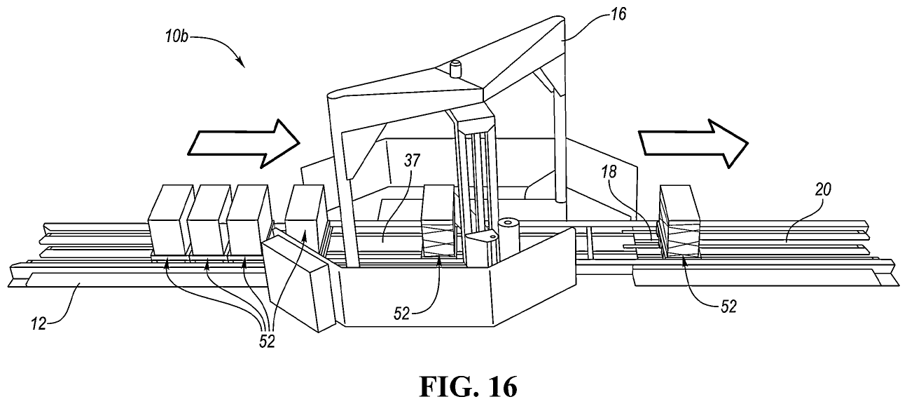

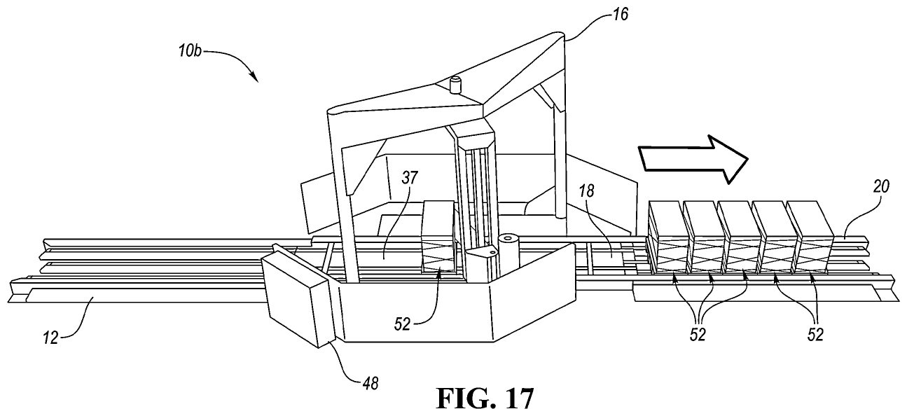

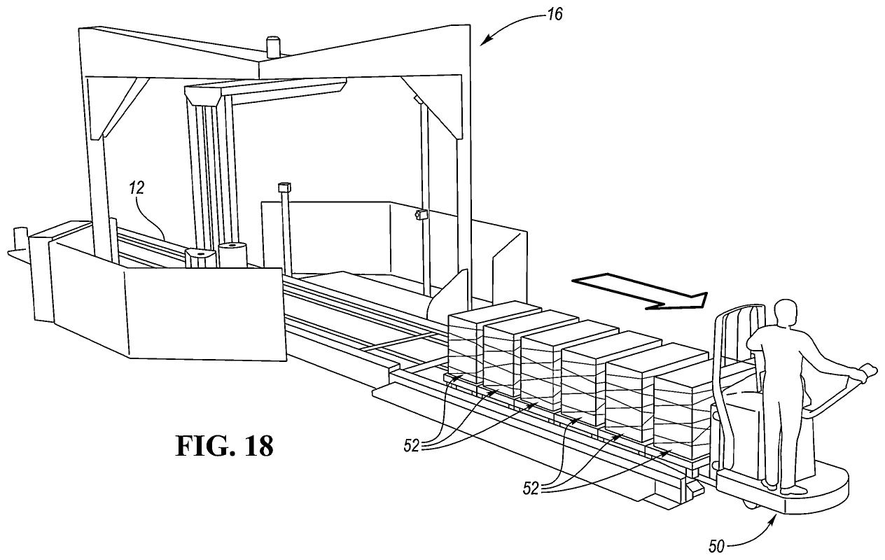

Referring to FIG. 16, the wrapper conveyor 37 is then controlled so that the first loaded, wrapped pallet 52 is moved to the weigh conveyor 18 where it is weighed and then transferred to the outfeed conveyor 20, at which time it passes the RFID reader 46 where a pallet RFID tag on the pallet 52 is read and passed to the computer. While the first loaded, wrapped pallet 52 is being weighed (for example), the next pallet 52 is moved by the transfer conveyor 14 to the wrapper conveyor 37 so that it can be wrapped and imaged by the wrapper 16. This continues until all of the loaded, wrapped pallets 52 are on the outfeed conveyor 20 as shown in FIG. 17. The wrapped, loaded pallets 52 can all be picked up by the walkie rider 50 as shown in FIG. 18. Again, while this imaging and wrapping process has been taking place, the user and the walkie rider 50 can be picking other orders and loading other pallets 52. The infeed conveyor 12 could be loaded with loaded pallets 52 at this time and may begin the process of feeding the loaded pallets 52 to the wrapper conveyor 37.

Again in this embodiment, the images of the loaded pallet 52, the RFID tag information, and the weight are sent to the computer 48 for SKU verification.

These systems 10, 10a, 10b simplify and speed up the pallet wrapping process in the warehouse after the load is picked to the pallet and before the pallet is loaded onto the trailer. Each system utilizes a high-speed pallet wrapper 16 along with an automated conveyance system to allow the warehouse picker to drop all loaded pallets 52 at once and return to picking the next batch. The conveyor system 10 is designed to be close to floor level so that a standard warehouse walkie rider can load single or multiple pallets onto it without requiring a forklift or similar apparatus. In other words, upper surfaces on which loaded pallets 52 are supported in the infeed conveyor 12 and the outfeed conveyor 20 are close enough to the floor that the tines can be moved under the pallets 52 and removed from under the pallets 52.

The systems 10, 10a, 10b consistently and effectively wrap each pallet 52 at a high throughput and allow the warehouse pickers to keep picking (versus waiting and/or wrapping pallets themselves) and automate the process. The load validation system including cameras 40, 42, 44 catches images of all sides of the loaded pallet 52. A weigh conveyor 18 weighs the loaded pallet 52 for unit load weight and an RFID reader 46 captures the pallet RFID tag and associates it with the images for asset tracking capabilities and load validation. The information from the pallet RFID tag, the images and the weight are sent to the computer 48 to be used for load verification, proof of delivery or asset management.

The system 10, 10a, 10b are modular so that the conveyors can be tailored to the specific location in terms of desired throughput, overall footprint/size, number of pickers, etc. This is accomplished through the design of the modular conveyance system including the infeed queue conveyor 24, infeed conveyor 12, queue conveyor, weight conveyor 18, wrapper conveyor 37, outfeed conveyor 20, and outfeed queue conveyor 22, any of which can connect to each other interchangeably. For example, additional queue conveyors could be added to either the infeed or outfeed section to allow for additional work-in-progress pallets to be in the automated cell so that pickers are not waiting to load their completed pallets. Again, as shown in FIG. 4, the modular configuration can also be used to place two or more cells side by side in an offset, parallel configuration to maximize pallet throughput per square foot of space required for the installation.

FIG. 19 shows a perspective view of a portion of an infeed conveyor 12c and an adjacent leading portion 54 that could be used in the systems 10, 10a, 10b of FIGS. 1-18. A ramp (not shown) gradually leads from the floor up to the height of the leading portion 54. The infeed conveyor 12c includes a plurality of conveying surfaces, such as drag chains 56 (in this example, three) on which the pallets 52 can be set and on which the pallets 52 would be moved along the infeed conveyor 12c. The infeed conveyor 12c also includes an upper floor 58 which is substantially flush with the upper support surface of the leading portion 54. The upper floor 58 is recessed slightly (approximately ½″) from the uppermost surface of the drag chains 56.

Alternatively, belts or other conveying surfaces could be used instead of the drag chains 56.

Optional guide rails 60 are positioned on either side of the drag chains 56 and have inner surfaces angled downward and inward to the upper floor 58.

The leading portion 54 is approximately the length of any walkie rider 50 (or sled, or pallet jack, or other material handling equipment), from the outer tip of the tines to a rearmost wheel, that will be used with the infeed conveyor 12c. The upper support surface of the leading portion 54 is planar and in the same plane as the upper floor 58 of the infeed conveyor 12c, at least enough to ensure that the tines will be sufficiently parallel to the upper floor 58 of the infeed conveyor 12c when they exit the pallets 52. In this example, the leading portion 54 is at least five feet long and preferably at least six feet long.

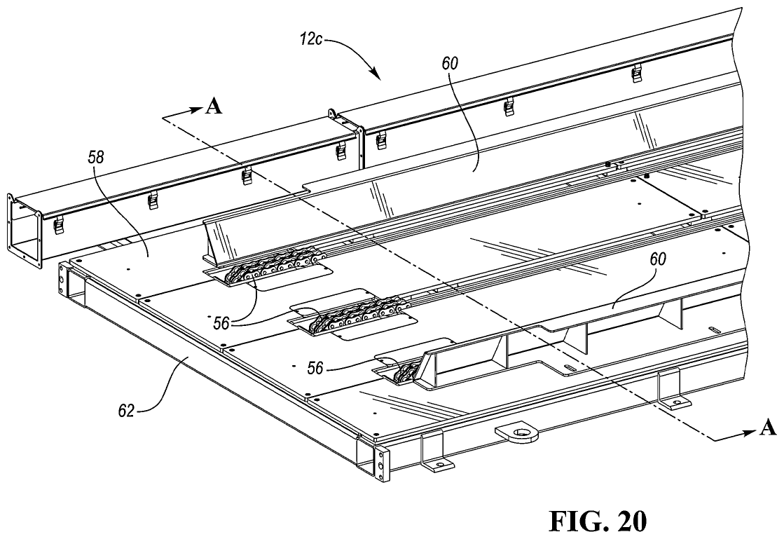

FIG. 20 is a front perspective view of the portion of the infeed conveyor 12 of FIG. 19. A frame 62 supports the upper floor 58 above the floor.

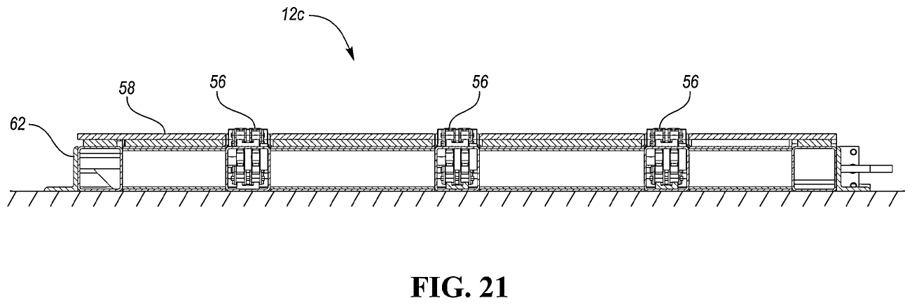

FIG. 21 is a section view taken along line A-A of FIG. 20. The frame 62 supports the upper floor 58 above the warehouse floor so that the gears and return courses of the drag chains 56 are below the upper floor 58. In other words, the drag chains 56 travel in the conveying direction at a height higher than the upper floor 58 and then return in the opposite direction at a height lower than the upper floor 58. As can be seen, the uppermost surface of the upper floor 58 is nearly flush with the drag chains 56. The uppermost surface of the upper floor 58 intersects the thickness of the upper course of the drag chains 56 (i.e. each drag chain 56 protrudes above the upper floor 58 by less than the thickness of the drag chain 56). In this example, the uppermost surface of the upper floor 58 is recessed approximately ½″ relative to the uppermost surface of the drag chains 56.

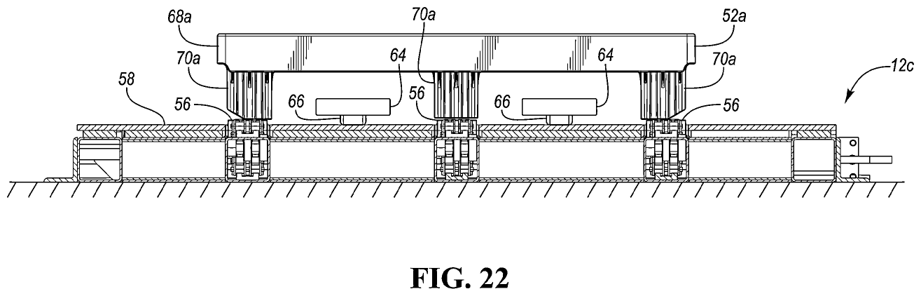

FIG. 22 shows the infeed conveyor 12c of FIG. 21 with a nestable pallet 52a supported thereon. The nestable pallet 52a includes a plurality of columns or feet 70a supporting a deck 68a. The feet 70a are each placed onto one of the drag chains 56. After the nestable pallet 52a is placed on the drag chains 56, the tines 64 of the walkie rider 50 (or pallet sled or pallet jack, etc) are lowered to the position shown, i.e. moved toward the load wheels 66 that support the tines 64. The tines 64 can then be rolled on the load wheels 66 out from below the nestable pallet 52a on the upper floor 58, onto the leading portion 54 (FIG. 19), and down the ramp to retrieve more pallets 52. Note that the tines 64 would carry and place a plurality of nestable pallets 52a at a time (e.g. FIG. 8). FIG. 22 just shows one of the nestable pallet 52a. Also, the nestable pallets 52a would be loaded with products as shown previously.

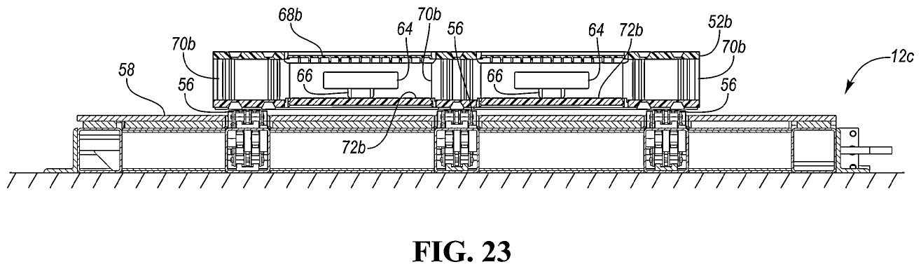

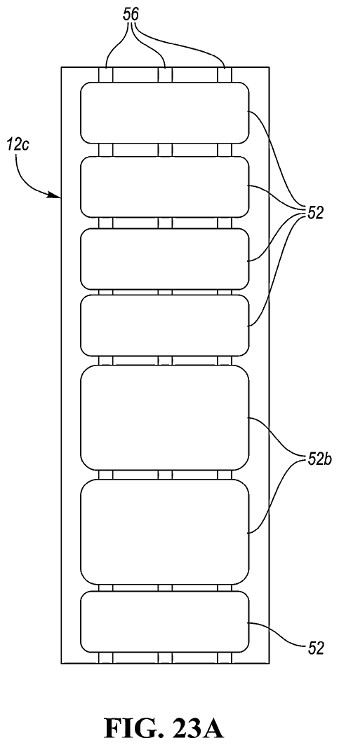

FIG. 23 shows the infeed conveyor 12c of FIG. 21 with a base board pallet 52b supported thereon. The base board pallet 52b includes a plurality of columns 70b supporting a deck 68b. Runners or base boards 72b extend between at least some adjacent ones of the plurality of columns 70b. The columns 70b are each placed onto one of the drag chains 56. After the base board pallet 52b is placed on the drag chains 56, the tines 64 of the walkie rider 50 (or pallet sled or pallet jack, etc) are lowered to the position shown, i.e. moved toward the load wheels 66 that support the tines 64. The tines 64 can then be rolled on the load wheels 66 over the base boards 72b. The base boards 72b are elevated above the upper floor 58 only by the amount that the drag chains 56 are proud of the upper floor 58 (in this example ½″). The tines 64 would be rolled out from below the base board pallet 52b on the upper floor 58, onto the leading portion 54 (FIG. 19), and down the ramp to retrieve more pallets 52. Note that the tines 64 would carry and place a plurality of base board pallet 52b at a time. FIG. 23 just shows one of the base board pallet 52b. Also, the base board pallet 52b would be loaded with products. The base board pallets 52b may be rackable pallets.

FIG. 23A is a top view of the infeed conveyor 12c with a plurality of nestable pallets 52a and a plurality of base board pallets 52b. It is also possible for the tines 64 to be loaded with one or more nestable pallets 52a and one or more base board pallets 52b at the same time, in any sequence. They can all be placed onto the drag chains 56 at the same time as shown in FIG. 23A. The tines 64 can then be removed in the same manner, with the load wheels 66 riding over the slightly elevated base boards 72b of the base board pallets 52b. The system 10c would operate as before.

Optionally, the front camera 42 (FIGS. 5 and 6) images the pallets 52a, 52b, and the computer determines the pallet type based upon the images. The wrapper 16 then wraps the pallet 52 in a manner that varies depending on what type of pallet it is. Any of the other cameras could also be used to identify the pallet type. Alternatively, if the RFID reader 46 is upstream of the wrapper 16, the RFID reader 46 could also determine the pallet type, which is associated with the information in the RFID tag.

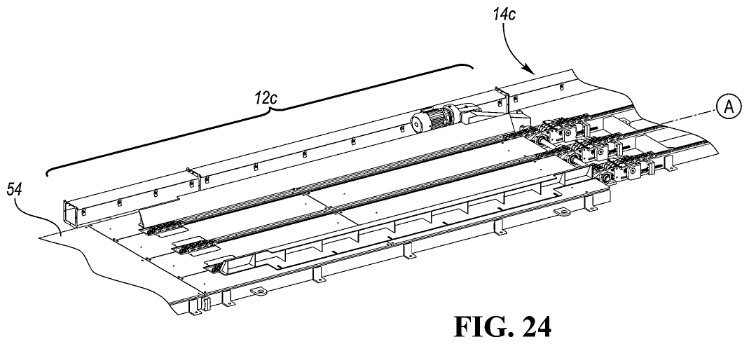

FIG. 24 is a perspective view of the entire infeed conveyor 12c of FIG. 19, between the leading portion 54 and the transfer conveyor 14c.

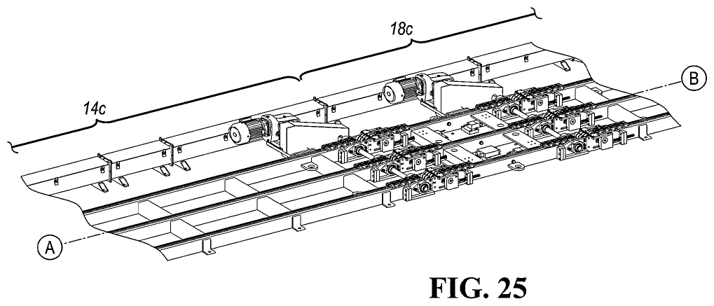

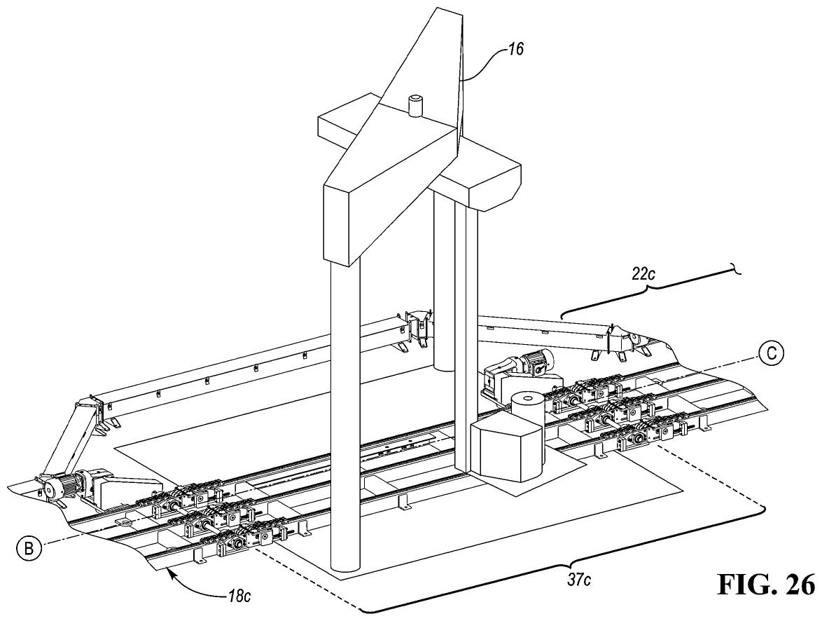

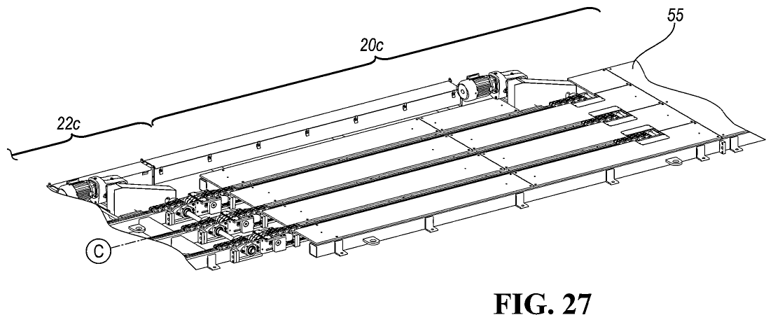

FIG. 25 is a perspective view of the transfer conveyor 14c and the weigh conveyor 18c. FIG. 26 is a perspective view of the weigh conveyor 18c, wrapper conveyor 37c, wrapper 16 and outfeed queue conveyor 22c. FIG. 27 is a perspective view of the outfeed queue conveyor 22c, the outfeed conveyor 20c, and an adjacent leadaway portion 55. The outfeed conveyor 20c and the leadaway portion 55 are mirror images of the infeed conveyor 12c and leading portion 54.

Together FIGS. 19 to 27 comprise a system that could be used in the systems 10, 10a, 10b of FIGS. 1-18 and used in a similar manner (with the same wrapper 16, cameras, computers, etc). Again, the system of FIGS. 19-27 is modular and could be configured according to any of the embodiments of FIGS. 1-18.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claim steps are for ease of reference in dependent claims only and do not signify a required sequence of steps unless other explicitly recited in the claims.

What is claimed is:

1. A conveyor system comprising:
a plurality of conveying surfaces spaced apart from one another; and
an upper floor between the plurality of conveying surfaces, wherein an uppermost surface of the upper floor is lower than an uppermost surface of the plurality of conveying surfaces and higher than a returning portion of the plurality of conveying surfaces.

2. The conveyor system of claim 1 wherein the uppermost surface of the plurality of conveying surfaces is approximately ½″ higher than the uppermost surface of the upper floor.

3. The conveyor system of claim 1 wherein the plurality of conveying surfaces includes a plurality of drag chains.

4. The conveyor system of claim 1 wherein the uppermost surface of the upper floor intersects a thickness of the plurality of conveying surfaces.

5. The conveyor system of claim 1 further including an adjacent portion having an upper support surface substantially flush with the uppermost surface of the upper floor.

6. The conveyor system of claim 5 wherein the upper support surface of the adjacent portion is planar and in a same plane as the uppermost surface of the upper floor.

7. The conveyor system of claim 6 wherein the adjacent portion is a leading portion and is at least five feet long.

8. The conveyor system of claim 1 in combination with at least one nestable pallet having feet supported on the plurality of conveying surfaces.

9. The combination of claim 8 further in combination with at least one base board pallet supported on the plurality of conveying surfaces.

10. The conveyor system of claim 6 wherein the plurality of conveying surfaces and the upper floor are part of an infeed conveyor, such that uppermost surfaces of the plurality of conveying surfaces move away from the adjacent portion.

11. The conveyor system of claim 10 wherein the plurality of conveying surfaces includes a plurality of drag chains.

12. The conveyor system of claim 11 wherein the uppermost surface of the upper floor intersects a thickness of the plurality of conveying surfaces.

13. The conveyor system of claim 6 wherein the plurality of conveying surfaces and the upper floor are part of an outfeed conveyor, such that uppermost surfaces of the plurality of conveying surfaces move toward from the adjacent portion.

14. The conveyor system of claim 13 wherein the plurality of conveying surfaces includes a plurality of drag chains.

15. The conveyor system of claim 14 wherein the uppermost surface of the upper floor intersects a thickness of the plurality of conveying surfaces.

16. A pallet wrapping system comprising:
a pallet wrapper configured to wrap plastic wrap around a plurality of items stacked on a pallet;
a wrapper conveyor configured to move a pallet through the pallet wrapper;
an infeed conveyor configured to transport pallets to the wrapper conveyor; and
an outfeed conveyor configured to receive pallets from the wrapper conveyor.

17. The pallet wrapping system of claim 16 further including:
an outfeed queue conveyor configured to receive pallets from the wrapper conveyor, wherein the outfeed conveyor is configured to receive pallets from the outfeed queue conveyor.

18. The pallet wrapping system of claim 17 further including:
a weigh conveyor configured to receive pallets from the outfeed queue conveyor and to transport pallets to the outfeed conveyor, wherein the weigh conveyor is configured to measure a weight of a loaded pallet thereon.

19. The pallet wrapping system of claim 16 further including:
an infeed queue conveyor configured to receive pallets from the infeed conveyor, wherein the infeed queue conveyor is configured to receive pallets from the infeed conveyor; and
a transfer conveyor configured to transfer a pallet from the infeed queue conveyor to the wrapper conveyor.

20. The pallet wrapping system of claim 16 further including:
at least one camera configured to take at least one image of packages stacked on a pallet in the pallet wrapping system; and
at least one computer configured to identify SKUs of the packages stacked on the pallet based upon the at least one image.

21. The pallet wrapping system of claim 20 wherein the at least one camera is secured to the pallet wrapper.

22. The pallet wrapping system of claim 21 wherein the at least one camera includes a plurality of cameras.

23. In combination:
a first pallet wrapping system comprising:
a first pallet wrapper configured to wrap plastic wrap around a plurality of items stacked on a pallet;
a first wrapper conveyor configured to move a pallet through the first pallet wrapper;
a first infeed queue conveyor configured to transport pallets to the first wrapper conveyor;
a first infeed conveyor configured to receive pallets from tines of material handling equipment and to transport pallets to the first infeed queue conveyor; and
a first outfeed conveyor configured to receive pallets from the first wrapper conveyor and to transfer pallets to tines of material handling equipment; and
a second pallet wrapping system comprising:
a second pallet wrapper configured to wrap plastic wrap around a plurality of items stacked on a pallet;
a second wrapper conveyor configured to move a pallet through the second pallet wrapper;
a second infeed conveyor configured to receive pallets from tines of material handling equipment and to transport pallets to the second wrapper conveyor;
a second outfeed queue conveyor configured to receive pallets from the second wrapper conveyor; and
a second outfeed conveyor configured to receive pallets from the second outfeed queue conveyor and to transfer pallets to tines of material handling equipment;
wherein the first pallet wrapper is positioned adjacent the second outfeed queue conveyor and wherein the second pallet wrapper is positioned adjacent the first infeed queue conveyor.

24. The combination of claim 23 wherein the first infeed conveyor is parallel to the second infeed conveyor.

25. The combination of claim 23 wherein a longitudinal axis of the first pallet wrapping system is parallel to a longitudinal axis of the second pallet wrapping system and wherein the first pallet wrapper is longitudinally offset from the second pallet wrapper.
